(19) United States
(12) Patent Application Publication
(10) Pub. No.: US 2011/0281247 A1
(43) Pub. Date: Nov. 17, 2011

(54) Method and System for Facilitating the Improvement of the State of Wellbeing of an Individual

(75) Inventor: Robert Whent, Tecumseh (CA)

(73) Assignee: OTEP Inc., Tecumseh (CA)

(21) Appl. No.: 13/154,495

(22) Filed: Jun. 7, 2011

(30) Foreign Application Priority Data
May 11, 2010 (CA) 2703448
Jun. 7, 2010 (CA) 2706031

(51) Int. Cl. G09B 19/00

(52) U.S. Cl. 434/236

(57) ABSTRACT

A method for facilitating the evaluation of the treatment of the state of wellbeing of an individual is provided. A first computer program for enabling a user to interact therewith via a user interface is executed. The first computer program enables a second computer program to communicate therewith. The second computer program is executed for communicating with the first computer program for collecting interaction data in dependence upon the interaction of the user with the first computer program. User state data are then determined in dependence upon the interaction data. The user state data are associated with a state of wellbeing of the user. Evaluation data are then determined in dependence upon the user state data for facilitating treatment of at least an attribute of the state of wellbeing of the user.

### FIELD OF THE INVENTION

The present invention relates to the field of improving the state of wellbeing and/or skills of an individual, and more particularly relates to a method and system for facilitating the improvement of the state of wellbeing and/or skills of an individual.

### BACKGROUND OF THE INVENTION

The evaluation and care/treatment processes related to the wellbeing of an individual such as, for example, the cognitive, mental and/or behavioral wellbeing of an individual is the foundation of maintaining and/or achieving good wellbeing. An appropriate evaluation and care/treatment process is typically performed in predetermined time intervals and comprises assessments of the state of wellbeing of the individual with the individual performing a series of tasks alone with a certified or trained assessor in unfamiliar surroundings and usually taking place over a time period of several hours and thereafter one or more care/treatment processes are undertaken to care for or treat any detected wellbeing issues.

Unfortunately, there are numerous factors that negatively influence this type of evaluation and care/treatment processes—such as, for example, having a bad day; headaches; personal trauma; shame; etc.—resulting in an improper evaluation and, therefore, improper diagnosis and improper medical treatment. In order to provide an accurate evaluation and appropriate care/treatment processes, they should preferably be performed in privacy, over a period of time.

Another disadvantage of this type of evaluation and care/treatment is the need for a certified or trained assessor to be present during the time of the assessment and care/treatment processes resulting in a substantial workload for specialized practitioners. Therefore, scheduling such an assessment and appropriate care/treatment processes typically takes weeks or months, impeding progress of the treatment.

It is desirable to provide a method and system for facilitating the evaluation and care/treatment processes of an individual while the individual is in a private setting.

It is also desirable to provide a method and system for facilitating the evaluation and care/treatment processes of an individual over a period of time.

It is also desirable to provide a method and system for facilitating the evaluation and care/treatment processes of an individual in a concealed fashion with respect to the individual.

### SUMMARY OF THE INVENTION

Accordingly, one object of the present invention is to provide a method and system for facilitating the evaluation and care/treatment processes of an individual while the individual is in a private setting.

Another object of the present invention is to provide a method and system for facilitating the evaluation and care/treatment processes of an individual over a period of time.

Another object of the present invention is to provide for facilitating the evaluation and care/treatment processes of an individual in a concealed fashion with respect to the individual.

According to one aspect of the present invention, there is provided a method for improving the wellbeing of an individual. A first computer program for enabling a user to interact therewith via a user interface is executed. The first computer program enables a second computer program to communicate therewith. The second computer program is executed for communicating with the first computer program for collecting interaction data in dependence upon the interaction of the user with the first computer program. User state data are then determined in dependence upon the interaction data. The user state data are associated with a state of wellbeing of the user. Evaluation data are then determined in dependence upon the user state data for improving the wellbeing of the individual.

According to another aspect of the present invention, there is further provided a storage medium having stored therein executable commands for execution on a processor. The processor when executing the commands communicates with a computer program. The computer program when executing enables a user to interact therewith via a user interface. During the communication the processor collects interaction data in dependence upon the interaction of the user with the computer program. The processor then determines user state data in dependence upon the interaction data. The user state data are associated with a state of wellbeing of the user. The processor then determines evaluation data in dependence upon the user state data for facilitating treatment of at least an attribute of the state of wellbeing of the user.

The advantage of the present invention is that it provides a method and system for facilitating the evaluation and care/treatment processes of an individual while the individual is in a private setting.

A further advantage of the present invention is that it provides a method and system for facilitating the evaluation and care/treatment processes of an individual over a period of time.

A further advantage of the present invention is that it provides for facilitating the evaluation and care/treatment processes of an individual in a concealed fashion with respect to the individual.

### BRIEF DESCRIPTION OF THE DRAWINGS

A preferred embodiment of the present invention is described below with reference to the accompanying drawings, in which:

FIG. 1 is a simplified block diagram illustrating a computer system for implementing a method for facilitating the assessment of the state of wellbeing of an individual according to a preferred embodiment of the invention;

FIG. 2a is a simplified flow diagram illustrating a method for collecting data for facilitating the assessment of the state of wellbeing of an individual for use with the method for facilitating the treatment of the state of wellbeing of an individual according to a preferred embodiment of the invention;

FIG. 2b is a simplified flow diagram illustrating an alternative embodiment of the method for collecting data for facilitating the assessment of the state of wellbeing of an individual illustrated in FIG. 2a; and,

FIGS. 3a and 3b are simplified flow diagrams illustrating the method for facilitating the treatment of the state of wellbeing of an individual according to a preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While embodiments of the invention will be described for use in assessing and facilitating the treatment of the wellbeing (including mental wellbeing, cognitive wellbeing, and behavioral wellbeing) of children, adolescents and/or adults (hereinafter referred to as “individual” or “individuals”) for the sake of simplicity, it will become evident to those skilled in the art that the embodiments of the invention are not limited thereto, but are also applicable for use in treating the state of wellbeing of an individual in numerous situations such as, for example, treating the state of wellbeing of the elderly, or training specific attributes such as, for example, alertness, reaction time, and hand-eye coordination, or the state of wellbeing of equipment operators such as pilots by collecting data during training on a flight simulator (also sometimes referred to herein as “individual” or “individuals”) and adjusting the functionality of the flight simulator over time.

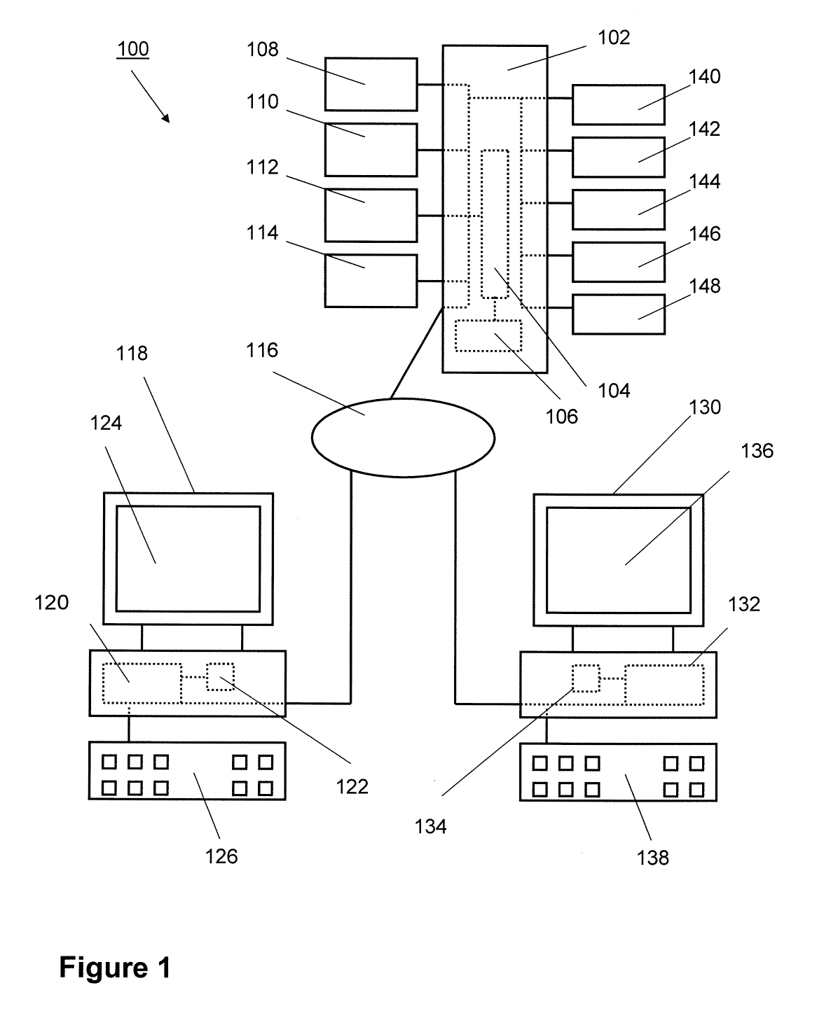

Referring to FIGS. 1, 2a, 2b, 3a, and 3b, a method for facilitating the assessment and treatment of the state of wellbeing of an individual according to a preferred embodiment of the invention is provided together with a preferred embodiment of a system for its implementation. To provide proper treatment it is necessary to perform a proper assessment of the state of wellbeing of the individual.

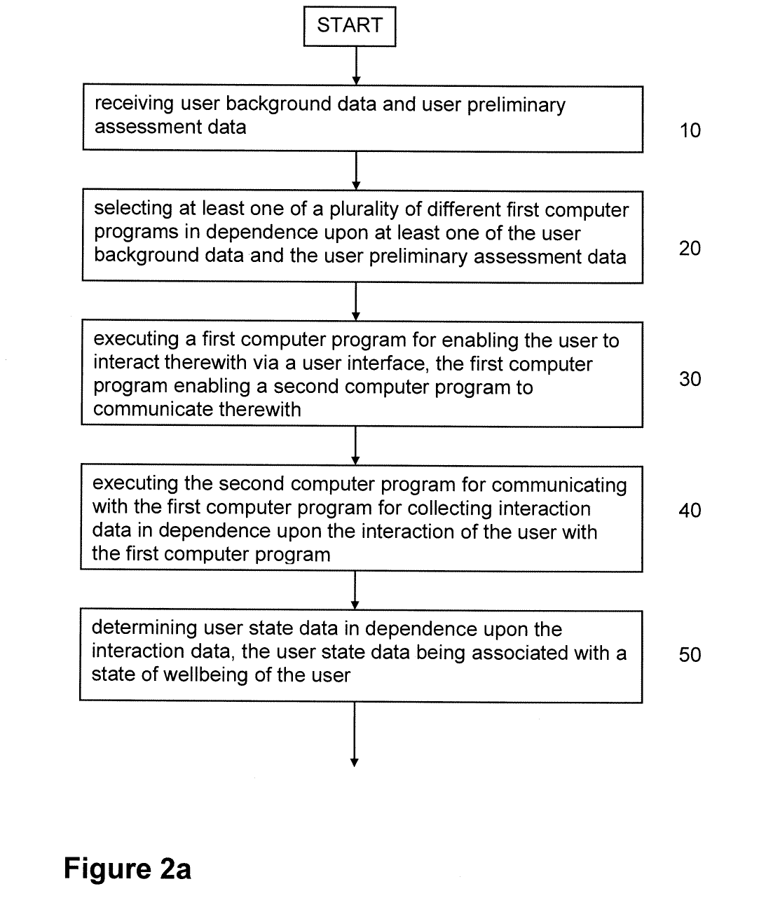

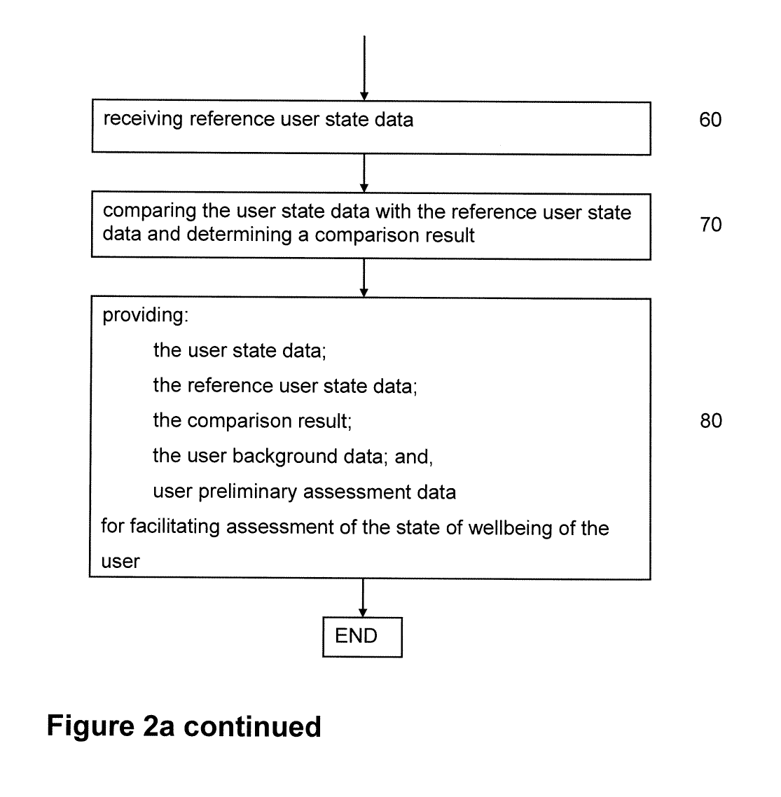

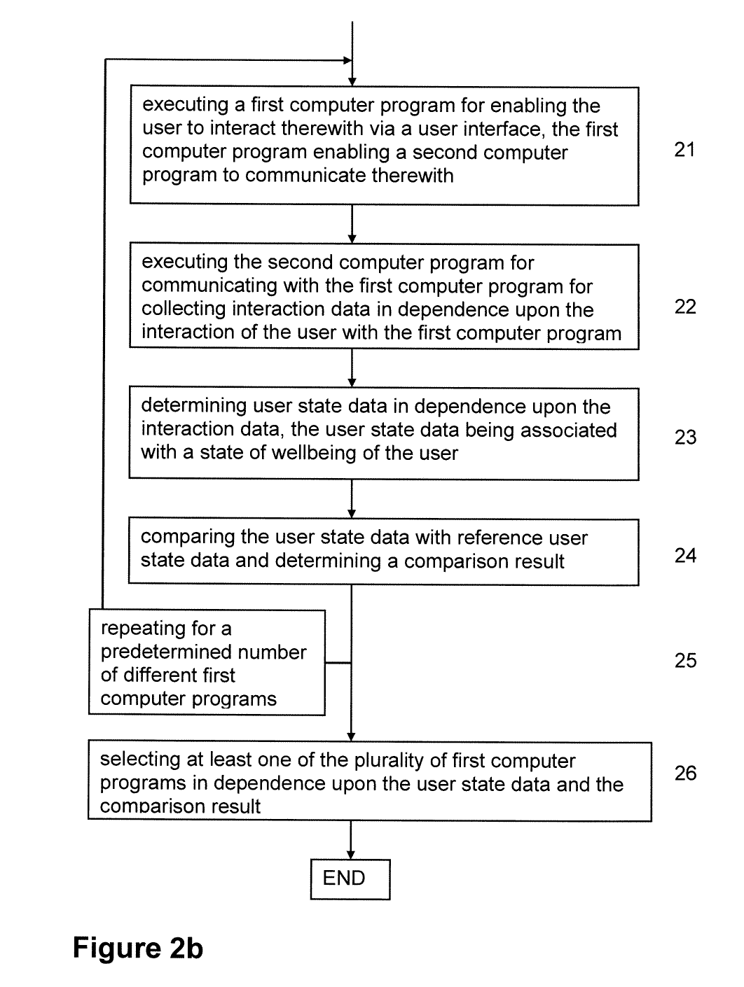

A preferred method for assessing of the state of wellbeing of the individual is described herein below with reference to FIGS. 1, 2a, and 2b, which is easily incorporated into the method for facilitating the treatment of the state of wellbeing of the individual. Of course, various other methods for assessing of the state of wellbeing of the individual are also employable.

With reference to FIGS. 1 and 2a, a personal computer 118 located in a private setting such as the home of an individual or a parent or a caregiver of the individual is connected via a communication network 116—such as, for example, the Internet—to a server computer 102 of an assessment service provider. Typically, the personal computer 118 comprises a processor 120, memory 122, monitor 124 and a user interface 126. For example, the individual or a parent or a caregiver of the individual first signs up with the assessment service provider by logging on to the assessment service provider's website displayed on the monitor 124 to open an account, which is performed using standard procedures and standard Internet technology. After opening of the account, the parents are provided with two questionnaires, with a first questionnaire comprising questions regarding the individual's background—for example, date of birth, birth history issues, medical history, age, sex, grade level achieved, current school performance, language skills, family income, parental education level, known medical conditions, etc.—and a second questionnaire comprising questions with respect to the parents assessment/observations regarding the individual's abilities—for example, visual processing, auditory processing, sequential/rational processing, conceptual/holistic processing, processing speed, memory, multitasking, reasoning, organization/prioritization, etc. Preferably, the data indicative of the answers to the first and second questionnaire are encoded using, for example, the processor 120 prior transmission to the server computer 102 via the communication network 116, or alternatively are encoded by server computer upon transmission of the data thereto from the processor 120. Upon receipt at 10, the data are stored, preferably, in a coded fashion, in respective databases, i.e. background data base 108 and preliminary assessment database 110.

Games database 112 has stored therein a plurality of computer programs of games, preferably, commercially available games such as, for example, a Tetris-like game for being played on a computer or video game consoles station such as, for example, Xbox or Wii having various types of user interfaces such as, for example, a mouse, keyboard, joystick, and/or microphone. Present-day computer programs typically have an interface embedded therein to enable interaction with other computer programs such as, for example, an Application Programming Interface (API).

At 20, in one embodiment of the present invention, at least one of the plurality of games are selected in dependence upon the answers provided by the parent, individual and/or caregiver in relation to the individual. Preferably, the selection is related to, for example, the individual's age, gender, left or right handedness or such other criteria elicited through one or more answers to questions asked on the questionnaire, or alternatively, is related to one or more of the individual's weaknesses as perceived by the parent and as elicited through one or more answers to the questionnaires, the selected games comprising at least a functionality that is associated with assessing the state of wellbeing of the individual playing the game. For example, a game may involve the individual seeing and identifying items that appear on the screen for short periods of time or another game involves an individual's alertness and hand-eye coordination by having the individual aiming a gun at a moving target. The APIs embedded in the game computer program enable another computer program to collect various data including data to the individual's visual abilities, vocabulary, alertness, hand-eye coordination, etc. Additionally, the APIs enable collection of data relating to other attributes of the individual's behaviour such as, for example, rapid irrelevant movement of a pointer/mouse or slow reaction. In respect of those games which do not have usable relevant APIs that enable another computer program to collect data including for example data relating to the individual's visual abilities, vocabulary, alertness, hand-eye coordination, etc., in one embodiment of the present invention, such games are modified to provide such APIs in a known manner.

Optionally, a game comprises an avatar which is adaptable to take on one or more characteristics of the individual based on, for example, one or more of the answers provided by the parent, individual and/or caregiver. For example, if the individual is a “good natured” individual, the avatar is adapted to represent a good natured person.

At 30, the selected game computer program is executed enabling the individual to play and to interact via a user interface. The selected game computer program is, for example, transmitted via the communication network to the personal computer 118, stored in the memory 122, and executed using the processor 120. Alternatively, the selected game computer program is remotely executed using, for example, processor 104 of the server computer 102 and communication therewith is provided via the communication network 116 to the personal computer 118 for the individual to interact therewith. As is evident, use of a personal computer is by example only and various other devices are also employable such as, for example, Xbox consoles, Wii consoles, video game consoles or wireless handheld devices.

At 40, an assessment computer program is executed, preferably using the processor 104 of the server computer 102 executing executable commands stored in memory 106, for communicating with the game computer program via the API embedded in the game computer program for collecting interaction data in dependence upon the interaction of the individual with the game computer program. Optionally, a translation layer is employed to enable communication between the game computer program and the assessment computer program. Via the APIs the assessment computer program collects data related to the interaction of the individual with the game computer program such as, for example, the reaction time between an object displayed on the display and the individual's reaction thereto, or the individual's accuracy in hitting a target displayed on the display. The interaction data are transmitted simultaneously during the execution of the game computer program or, alternatively, stored, for example, in the memory 122 and transmitted—in predetermined time intervals or upon a request generated during execution of the assessment computer program—to the processor 104.

At 50, user state data are determined in dependence upon the collected interaction data. The user state data are associated with a state of wellbeing of the individual. Preferably, the interaction data are associated with respective levels or ratings. For example, a very slow reaction time of the individual to a functionality of the game is associated with a level of 5, a very fast reaction time is associated with a level of 1, and reaction times there between are associated with levels 2, 3, and 4, accordingly. Preferably, the user state data also comprises at least some of the background data and the preliminary assessment data, for example, by associating a “NO” in a parent's answer with “0” and a “YES” with “1”.

TABLE 1
Indicator ID

| | |
|---|---|
| 0 | - no |
| 1 | - yes |
| 2 | Level 1 |
| 3 | Level 2 |
| 4 | Level 3 |
| 5 | Level 4 |
| 6 | Level 5 |
| 7 | Rating 1 |
| 8 | Rating 2 |
| 9 | Rating 3 |
| A | Rating 4 |
| B | RESERVED |
| C | RESERVED |
| D | RESERVED |
| E | RESERVED |
| F | RESERVED |

Table 1 illustrates the association of the answers as well as the levels and ratings with hexadecimal characters. The user state data are then meta-tagged and saved in assessment database 114 as a unique string of characters such as, for example, A23DF323211111000012EAABC1212AACA+.

Of course, there are numerous possibilities of associating and storing the data.

Optionally, reference user state data are provided—60. The reference user state data are, for example, data based on the interaction data of a healthy individual of a same age playing the same game. At 70, the user state data are compared with the reference user state data to determine a comparison result indicative of, for example, a difference between the user state data and the reference user state data and a margin of error. Of course, there are numerous other possibilities of comparing the data, for example, as percentages or ratios, etc.

At 80, the data, preferably, comprising the user state data, and for example, the reference state data, the comparison result and at least some of the background data and preliminary assessment data are then provided to the individual, or to the parent or caregiver of the individual. For example, the individual, or the parent or caregiver of the individual, using the personal computer 118 access the account set up for the individual with the assessment service provider via the communication network 116 and are provided with the data. The individual, or the parent or caregiver of the individual is then able to forward the data to a third party for evaluation such as a medical practitioner for facilitating the medical practitioner's assessment and diagnosis of the state of wellbeing of the individual. Alternatively, the data are directly provided to the medical practitioner's computer 130 via the communication network 116, where the data are processed using processor 132 for displaying in a human comprehensible form on display 136. Optionally, the medical practitioner is enabled to further process the data via user interface 138 suitable for a diagnosis and to store the data in memory 134 for future reference. Alternatively, the data is stored for reference and/or access and display by the individual, parent or caregiver, or other third party.

The method for collecting data for facilitating the assessment of the state of wellbeing of an individual enables the collection of the interaction data in a fashion that is concealed from the individual, thus enabling assessments in the privacy of the individual's home and at the leisure of the individual's play. Furthermore, the method enables collection of the interaction data over a period of time. For example, every time when the individual plays the game, the game computer program communicates with the assessment program; collects the interaction data; and transmits the same to the processor 104.

The assessment computer program is, for example, stored as executable commands in the memory 106 of the server computer 102 and executed on the processor 104. Standard programming technologies are employed for implementing the method for collecting data for facilitating the assessment of the state of wellbeing of an individual using, for example, standard game computer programs having APIs embedded therein, object oriented programming techniques, and Structured Query Language (SQL) for managing the databases, but are not limited thereto. As is evident, the method for collecting data for facilitating the assessment of the state of wellbeing of an individual is not limited to game computer programs but is also implementable using computer programs for other applications such as, for example, text editors and flight simulators or other computer programs or applications.

In an alternative embodiment, the game computer program is selected in a different fashion, i.e. step 20 in FIG. 2a is replaced by steps 21 to 26 illustrated in FIG. 2b. At 21, a first game computer program is executed and interaction data of the individual playing therewith are collected—22. User state data are then determined—23—in dependence upon the collected interaction data and, optionally, compared—24—with reference user state data to determine a comparison result. The steps 21 to 24 are then repeated—25—for a predetermined number of different game computer programs. The user state data and, optionally, the comparison result then provide an indication of any negative deviations in the individual's abilities relative to the reference user state data and at least one of the game computer programs is then selected—26—in dependence upon the user state data and, optionally, the comparison result, which functionalities best address any negative deviations in the individual's abilities relative to the reference user state data.

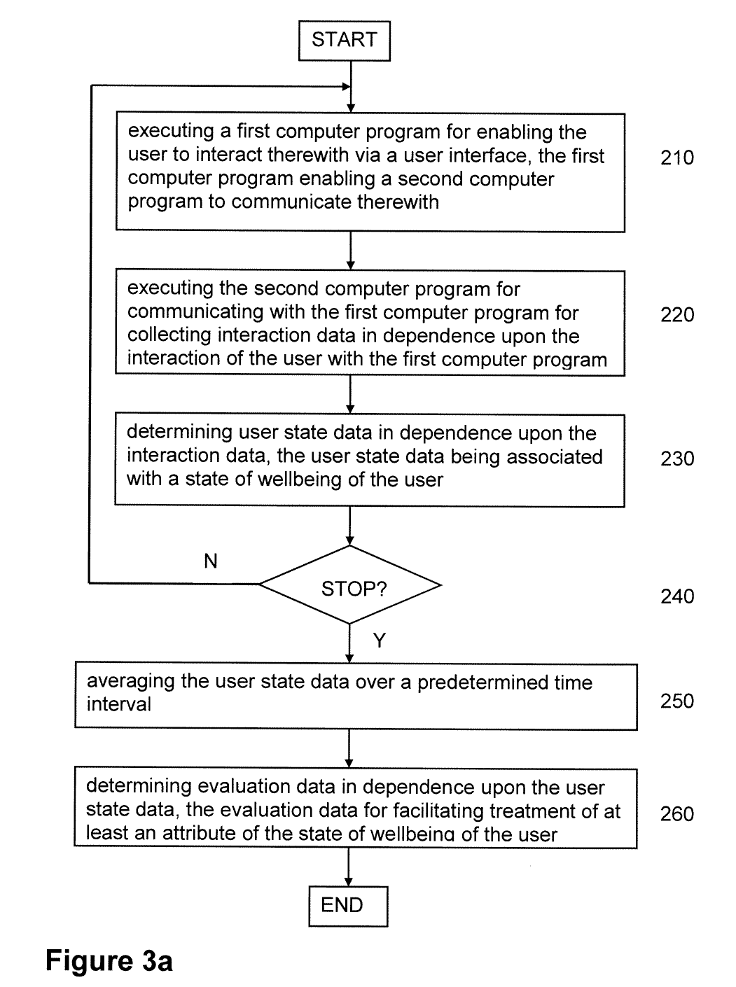

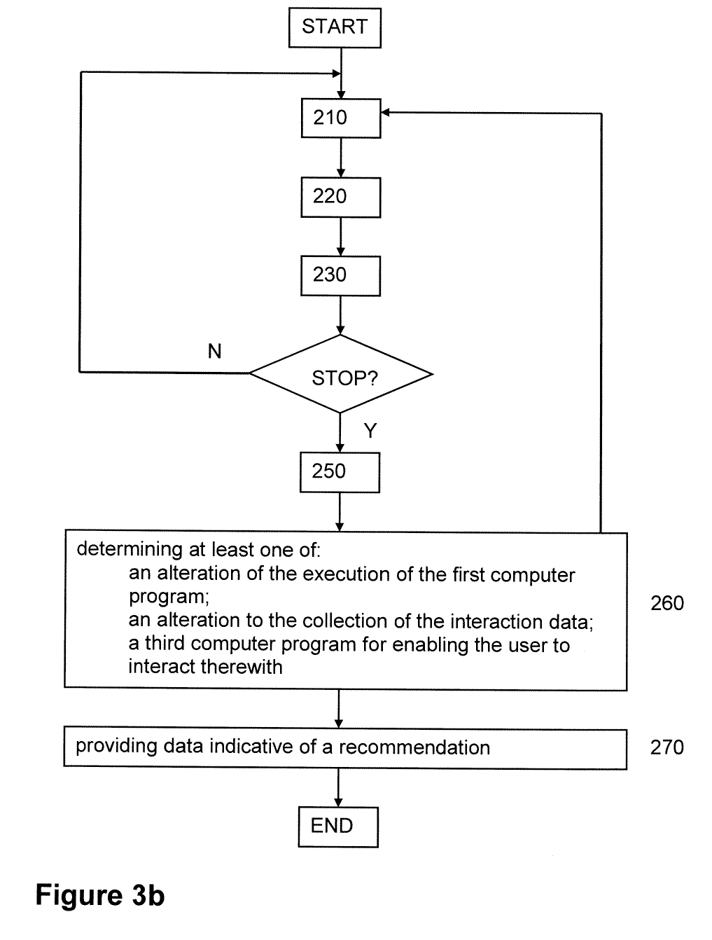

Preferably, the method for facilitating the treatment of the state of wellbeing of an individual is implemented together with the method for facilitating the assessment of the state of wellbeing of an individual using a same computer system for example, the computer system illustrated in FIG. 1, but is not limited thereto. Referring to FIGS. 3a and 3b, a preferred embodiment of the method and system for facilitating the treatment of the state of wellbeing of an individual is provided.

At 210, a game computer program is executed enabling the individual to play and to interact via a user interface. The game computer program is, for example, transmitted via the communication network to the personal computer 118, stored in the memory 122, and executed using the processor 120. Alternatively, the game computer program is remotely executed using, for example, processor 104 of the server computer 102 and communication therewith is provided via the communication network 116 to the personal computer 118 for the individual to interact therewith. As is evident, use of a personal computer is by example only and various other devices are also employable such as, for example, Xbox consoles, Wii consoles, video game consoles or wireless handheld devices.

At 220, a treatment computer program is executed, preferably using the processor 104 of the server computer 102 executing executable commands stored in memory 106, for communicating with the game computer program via an API embedded in the game computer program for collecting interaction data in dependence upon the interaction of the individual with the game computer program. Optionally, a translation layer is employed to enable communication between the game computer program and the treatment computer program. Via the APIs the treatment computer program collects data related to the interaction of the individual with the game computer program such as, for example, the reaction time between an object displayed on the display and the individual's reaction thereto, or the individual's accuracy in hitting a target displayed on the display. The interaction data are transmitted simultaneously during the execution of the game computer program or, alternatively, stored, for example, in the memory 122 and transmitted—in predetermined time intervals or upon a request generated during execution of the assessment computer program—to the processor 104.

At 230, user state data are determined in dependence upon the collected interaction data. The user state data are associated with a state of wellbeing of the individual. Preferably, the interaction data are associated with respective levels or ratings. For example, a very slow reaction time of the individual to a functionality of the game is associated with a level of 5, a very fast reaction time is associated with a level of 1, and reaction times there between are associated with levels 2, 3, and 4, accordingly. The user state data are then meta-tagged and saved in treatment evaluation database 140 as a unique string of characters. Of course, there are numerous possibilities of associating and storing the data.

The steps 210 to 230 are repeated until a stopping criterion is met—240. Suitable stopping criterions are, for example, a predetermined number of executions of the game computer program, a predetermined time interval, or a request to stop.

Preferably, the user state data are averaged, for example, over the predetermined time interval, subsets of smaller time intervals, or predetermined number of executions of the game computer program—250. Averaging substantially cancels fluctuations in the user state data due to changes in the condition of the individual such as, for example, having a bad day. Averaging over subsets enables revealing a trend in the user state data during, for example, the predetermined time interval.

At 260, evaluation data are determined in dependence upon the user state data. The evaluation data facilitate the treatment of at least an attribute—such as, for example, the cognitive skills—of the state of wellbeing of the user. Step 260 comprises at least one of: determining an alteration of the execution of the first computer program; determining an alteration to the collection of the interaction data; and, determining a third computer program for enabling the user to interact therewith. Treatment data associating the reference user state data with respective data indicative of: an alteration of the execution of the first computer program; an alteration to the collection of the interaction data; and, other computer programs for enabling the user to interact therewith are stored in treatment database 142 connected to the processor 104 of the server computer 102. Preferably, the treatment data are stored as unique strings of characters. The averaged user state data are then compared with the reference user state data stored in the treatment database 142 to produce a comparison result and the respective data associated therewith are retrieved in dependence upon the comparison result.

For example, during treatment the state of wellbeing of the individual improves enabling the individual to meet higher level requirements. If the reference user state data are indicative of the individual being able to go to a higher level, for example, the reference user state data are indicative of an improvement in reaction time and hand-eye coordination, then execution of the program is altered requiring a faster reaction by displaying a target a shorter time or moving the target faster. In a similar fashion the collection of the interaction data is altered or the computer program is changed. Optionally, when the user state data have been averaged over subsets the trend is considered in step 260.

Recommendation data associating the reference user state data with respective data indicative of a recommendation are stored in recommendation database 144 connected to the processor 104 of the server computer 102. Preferably, the treatment data are stored as unique strings of characters. The averaged user state data are then compared with the reference user state data stored in the recommendation database 144 to produce a comparison result and the respective data associated therewith are retrieved in dependence upon the comparison result—270. Recommendations comprise, for example, referral services, parenting tips, and other available tools and services for treatment. For example, the parent or caregiver is provided with a message displayed on the monitor 124 indicating the user state data, suggestions to alter the execution of the game computer program or to change the game computer program, and recommendations.

Optionally, data indicative of other products related to the treatment are stored in product database 146 connected to the processor 104 of the server computer 102. For example, the data indicative of other products are associated with the reference user state data and provided in the message to the individual or parent or caregiver in dependence upon their relevance to the user state data. Alternatively, the individual or parent or caregiver is enabled to access the product database 146 and browse its content.

Further optionally, data indicative of links to other parents or caregivers or individuals encountering similar problems who have indicated interest in communicating with others are stored in social network database 148 connected to the processor 104 of the server computer 102. For example, the social network data are associated with the reference user state data and provided in the message to the individual or parent or caregiver in dependence upon their relevance to the user state data. Alternatively, the individual or parent or caregiver is enabled to access the social network database 148 and browse its content.

After determining at least one of: an alteration of the execution of the first computer program; an alteration to the collection of the interaction data; a third computer program for enabling the user to interact therewith in step 260 the processor provides data indicative thereof to a processor executing the first computer program. Step 210 is then performed with at least one of: an alteration of the execution of the first computer program; an alteration to the collection of the interaction data; a third computer program for enabling the user to interact therewith and the above process is repeated, as illustrated in FIG. 3b. For example, the third computer program is provided from games database 112 for execution on the processor 120 of the personal computer 118 or on the processor 104 of the sever computer 102. Optionally, the individual's or parent's or caregiver's permission is requested before performing step 210 with the alterations.

The method for facilitating the treatment of the state of wellbeing of an individual enables the collection of the interaction data in a fashion that is concealed from the individual, thus enabling evaluation of the treatment in the privacy of the individual's home and at the leisure of the individual's play. Furthermore, the method enables collection of the interaction data over a period of time. For example, every time when the individual plays the game, the game computer program communicates with the treatment evaluation program; collects the interaction data; and transmits the same to the processor 104.

The treatment evaluation computer program is, for example, stored as executable commands in the memory 106 of the server computer 102 and executed on the processor 104. Standard programming technologies are employed for implementing the method for collecting data for facilitating the evaluation of the treatment of the state of wellbeing of an individual using, for example, standard game computer programs having APIs embedded therein, object oriented programming techniques, and Structured Query Language (SQL) for managing the databases, but are not limited thereto. As is evident, the method for collecting data for facilitating the evaluation of the treatment of the state of wellbeing of an individual is not limited to game computer programs but is also implementable using computer programs for other applications such as, for example, text editors and flight simulators or other computer programs or applications.

In one embodiment of the present invention, the method and system may be utilized and implemented without any input or supervision or diagnosis or treatment or any other participation by a medical doctor or other trained or licensed practitioner.

In one embodiment of the present invention, the methodology may be employed to improve an individual's abilities to play games. For example, an individual who wishes to improve those characteristics associated with successful game play, would be treated by playing the desired game and concentrating on areas of weakness in that particular game until the desired results are obtained.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A method comprising:
a) executing a first computer program for enabling a user to interact therewith via a user interface, the first computer program enabling a second computer program to communicate therewith;
b) executing the second computer program for communicating with the first computer program for collecting interaction data in dependence upon the interaction of the user with the first computer program;
c) determining user state data in dependence upon the interaction data, the user state data being associated with a state of wellbeing of the user; and,
d) determining evaluation data in dependence upon the user state data, the evaluation data for facilitating treatment of at least an attribute of the state of wellbeing of the user.

2. A method as defined in claim 1 wherein d) comprises at least one of:
determining an alteration of the execution of the first computer program;
determining an alteration to the collection of the interaction data;
determining a third computer program for enabling the user to interact therewith; and,
determining data indicative of a recommendation.

3. A method as defined in claim 2 wherein d) comprises comparing the user state data with reference user state data and determining the evaluation data in dependence upon the comparison.

4. A method as defined in claim 3 comprising providing association data associating the reference user state data with respective data indicative of at least one of:
an alteration of the execution of the first computer program;
an alteration to the collection of the interaction data;
a third computer program for enabling the user to interact therewith; and,
a recommendation.

5. A method as defined in claim 2 comprising repeating a) to c) until a stopping criterion is met.

6. A method as defined in claim 5 wherein the stopping criterion is one of:
a predetermined time interval;
a predetermined number of executions of the first computer program; and,
a request to stop.

7. A method as defined in claim 5 comprising averaging the user state data.

8. A method as defined in claim 5 wherein a) comprises one of:
executing the first computer program in an altered fashion; and,
replacing the first computer program with the third computer program and executing the third computer program.

9. A method as defined in claim 1 wherein the user interaction is related to playing a game, the game comprising at least a functionality associated with the at least an attribute of the state of wellbeing of the user.

10. A method as defined in claim 1 wherein the first computer program enables the second computer program to communicate therewith via an application programming interface.

11. A method as defined in claim 1 wherein the first computer program is executed using a first processor and wherein the user state data are provided to a second processor connected to the first processor via a communication network.

12. A method as defined in claim 11 wherein the second computer program is executed using the second processor.

13. A method as defined in claim 1 wherein the interaction data are collected in a concealed fashion with respect to the user.

14. A storage medium having stored therein executable commands for execution on a processor, the processor when executing the commands performing:
a) communicating with a computer program, the computer program when executing enabling a user to interact therewith via a user interface;
b) collecting interaction data in dependence upon the interaction of the user with the computer program;
c) determining user state data in dependence upon the interaction data, the user state data being associated with a state of wellbeing of the user; and,
d) determining evaluation data in dependence upon the user state data, the evaluation data for facilitating treatment of at least an attribute of the state of wellbeing of the user.

15. A storage medium as defined in claim 14 wherein the processor when determining the evaluation data performs at least one of:
determining an alteration of the execution of the first computer program;
determining an alteration to the collection of the interaction data;
determining a third computer program for enabling the user to interact therewith; and,
determining data indicative of a recommendation.

16. A storage medium as defined in claim 15 wherein the processor when executing the commands performs repeating a) to c) until a stopping criterion is met.

17. A storage medium as defined in claim 16 wherein the processor when executing the commands averages the user state data.

18. A storage medium as defined in claim 14 wherein the processor when executing the commands collects the interaction data in a concealed fashion with respect to the user.
